(19) United States
(12) Patent Application Publication
(10) Pub. No.: US 2017/0072910 A1
(43) Pub. Date: Mar. 16, 2017

(54) LONGITUDINAL STRUCTURAL ELEMENT FOR A WINDSCREEN WIPER

(71) Applicant: Valeo Systèmes d'Essuyage, Le Mesnil Saint Denis (FR)

(72) Inventors: Lionel Cros, La Roche Blanche (FR); Jean-Michel Jarasson, Le Mesnil Saint Denis (FR); Gérald Caillot, Cernay La Ville (FR); Vincent Izabel, Chilly Mazarin (FR)

(73) Assignee: Valeo Systèmes d'Essuyage, Le Mesnil Saint Denis (FR)

(21) Appl. No.: 15/123,302

(22) PCT Filed: Feb. 9, 2015
(86) PCT No.: PCT/EP2015/052666

§ 371 Date: Sep. 2, 2016

(30) Foreign Application Priority Data
Mar. 7, 2014 (FR) 1451844

(51) Int. Cl. B60S 1/38

(52) U.S. Cl. CPC B60S 1/3805; B60S 1/381; B60S 2001/3898

(57) ABSTRACT

Longitudinal structural element (30a) for a windscreen wiper (10′), in particular of a motor vehicle, said structural element having a non-metallic main body, characterized in that said main body comprises at least one part (39) made of a thermally conductive material or covered with a non-metallic thermally conductive material.

The present invention relates notably to a longitudinal structural element for a wiper blade, particularly for a motor vehicle.

Typically, a wiper blade for a window glass such as the windshield of a motor vehicle comprises a first longitudinal cover member bearing an aerodynamic deflector, and a second longitudinal member supporting a blade rubber, generally made of rubber, which is intended to rub against the window glass of the vehicle in order to remove the water, moving it out of the driver's field of view. The second member also serves to support a longitudinal spine which stiffens the blade rubber in order to encourage this rubber to press firmly against the windshield. The blade is borne by an arm which is driven by a motor in an angular back and forth movement. The means of connecting the blade to the arm generally comprise a connector which is secured to the blade and an adapter which is articulated to the connector and fixed to one end of the arm.

The second member or support member defines a first longitudinal housing for accommodating the stiffening spine and a second longitudinal housing for accommodating a heel of the blade rubber. Each of these housings is delimited by a bottom wall, generally horizontal (in the service position), and two lateral walls, generally vertical, which are connected to said bottom wall.

At rest, the stiffening spine has a concave curved lower face and a convex curved upper face. The spine is mounted in the first housing of the support member in such a way that its concave face faces toward the windshield of the vehicle.

Wiper blade heating devices comprising a heating element incorporated into the wiper blade and generally extending along the length thereof are known. The heating element allows ice or snow which may form or build up on the wiper blade to be melted. Such a heating element is of particular utility for a wiper blade provided with a washer fluid distribution line. The heating element in this case allows the distribution line to be heated up, particularly the distribution holes, so as to allow the liquid to leave and wash the windshield of the vehicle.

When the heating element is in the form of a heating film or of a heating coating, this heating element may be applied by gluing or some other means of adhesion to the concave lower face of the spine.

In the current state of the art, the support member of the wiper blade is made from a plastics material that is not thermally conducting. It is made, for example, of polypropylene (PP), the thermal conductivity of which is markedly below 1 W.m⁻¹.K⁻¹ (at 20° C.)

In order to improve the heating of the blade, one solution is to increase the thermal power of the heating film. However, this solution is unsatisfactory because it carries the risk of degrading the material of the support member which is not designed to withstand high temperatures, especially when the heating film is in direct contact with the aforementioned bottom wall of the support member.

The invention proposes a simple, effective and economic solution to this problem.

The invention proposes a longitudinal structural element for a wiper blade, particularly for a motor vehicle, said structural element comprising a non-metallic main body, characterized in that said main body comprises at least a part made from a thermally conducting material, preferably a non-metallic thermally conducting material, or covered with a layer of a non-metallic thermally conducting material.

The invention may be applied to any longitudinal structural element of a wiper blade, such as, for example, its support member or its cover member. However, the invention is not applicable to a stiffening spine the main body or core of which is made of metal.

According to the invention, although the main body of the structural element is made from a non-metallic material, it is made at least in part from a thermally conducting material or it is covered at least in part with a layer of non-metallic thermally conducting material (which may itself be metallic).

In what follows, a thermally conducting material is to be understood as meaning a non-metallic thermally conducting material which may be non-resistive (not intended to produce heat energy when supplied with electrical energy). In the present application, a thermally conducting material is to be understood as meaning a material capable of transmitting thermal energy. For preference, the thermally conducting material has a thermal conductivity greater than or equal to 1 W.m⁻¹.K⁻¹, preferably greater than or equal to 5 W.m⁻¹.K⁻¹, and more preferably greater than or equal to 10 W.m⁻¹.K⁻¹ (at 20° C.).

The thermally conducting material may comprise thermally conducting fillers (such as graphite, carbon fibers, ceramic fillers, etc). These fillers may be embedded in a binder (for example a homopolymer or copolymer based on polypropylene or polyethylene).

A structural element is to be understood to mean an element that is rigid enough to contribute to the actual structure and, for example, to the integrity of a wiper blade. The structural elements of a wiper blade generally comprise the cover and support members, the deflector when this is independent of the support member and added thereto, and the stiffening spine.

The main body of such a structural element extends as the essential part of this element. In the case of a spine, its main body is its core. In the case of a support member, it is the support member itself, and in the case of a cover member, it is the cover member itself. If one of these members bears a particular element, such as a heating element, this particular element does not have to be considered to form part of the main body of the member.

According to one embodiment of the invention, the main body of the structural element comprises a longitudinal housing for accommodating a longitudinal stiffening spine, said housing being delimited at least in part by a bottom wall and two lateral walls which are connected to said bottom wall, at least part of said bottom wall being produced from said thermally conducting material or covered with said layer of non-metallic thermally conducting material.

The main body of the structural element may further comprise a longitudinal housing to house a heel of a wiper blade rubber.

The main body may further comprise at least one longitudinal channel for the passage of fluid and/or an aerodynamic deflector. When the main body comprises one or more channels for the passage of fluid such as washer fluid, the invention makes it easier to deice this or these, particularly in the winter.

The present invention also relates to an assembly comprising a structural element as described hereinabove, and a heating element, such as a heating film, said heating element being configured to heat said at least one part or said layer.

The invention may further comprise a longitudinal stiffening spine, said spine being mounted in said housing of the body and comprising, at rest, a concave curved lower face, said heating element being interposed between said lower face of the spine and said bottom wall of the body.

The heating element is preferably fixed to said lower face of the spine and is either spaced away from said bottom wall or in contact therewith. As an alternative, the heating element is fixed to said bottom wall.

The main body may be made in its entirety from thermally conducting material.

As an alternative, the main body may be made, preferably by co-extrusion, from two materials, one of which is said thermally conducting material.

The present invention also relates to a wiper blade, particularly for a motor vehicle, comprising a structural element as described hereinabove or an assembly as described hereinabove.

The present invention finally relates to a method of manufacturing a structural element as described hereinabove, characterized in that it comprises:
a step of extruding its main body from a thermally conducting material, or
a step of co-extruding its main body from a thermally conducting material and another material that is not thermally conducting, or
a step of extruding its main body from a material that is not thermally conducting, followed by a step of applying a layer of non-resistive thermally conducting material to part of said body.

The invention will be better understood and further details, features and advantages of the invention will become apparent from reading the following description given by way of nonlimiting example with reference to the attached drawings in which:

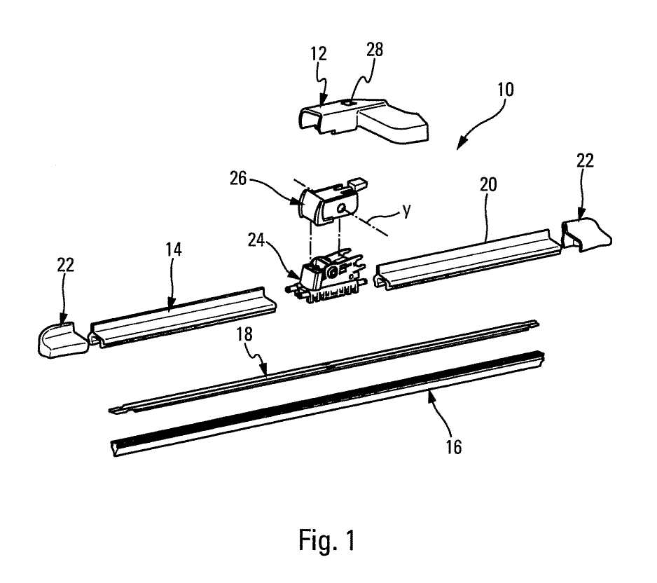

FIG. 1 schematically depicts a perspective view of a wiper blade connected to a wiper arm,

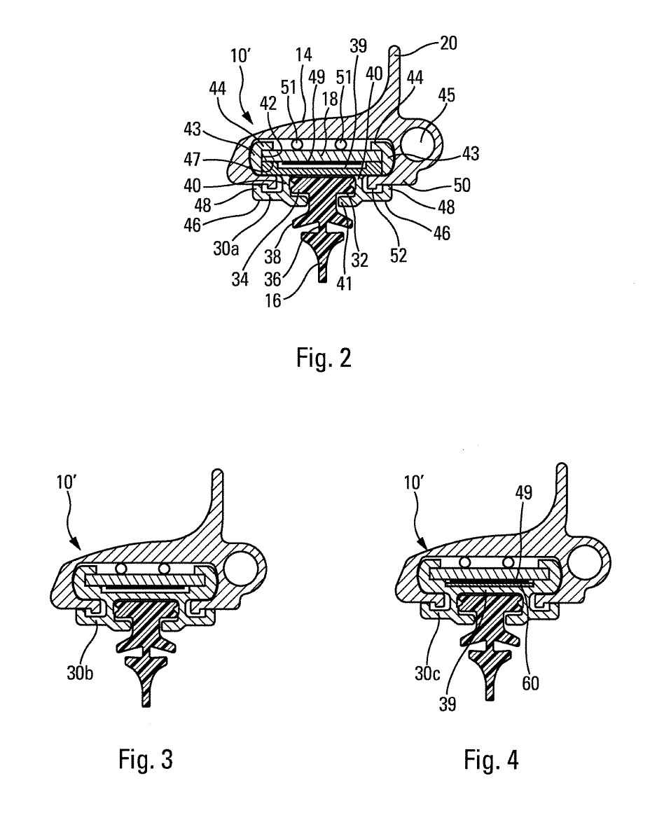

FIG. 2 schematically depicts a view in cross section of one embodiment of the wiper blade according to the invention, and

FIGS. 3 to 15 schematically depict views in cross section of alternative forms of embodiment of the wiper blade according to the invention.

It should be noted that the figures set out the invention in detail so that the invention can be carried out, it being of course possible for said figures to be used if necessary for defining the invention better.

In the description that follows, denominations of longitudinal or lateral refer to the orientation of the wiper blade according to the invention. The longitudinal direction corresponds to the main axis of the blade in which it extends, whereas the lateral orientations correspond to concurrent straight lines, which means to say lines that cross the longitudinal direction, notably perpendicular to the longitudinal axis of the blade in its plane of rotation. In the case of the longitudinal directions, the denominations exterior or interior are to be assessed in relation to the point of attachment of the blade to a blade carrying arm, the denomination interior corresponding to the part where the arm and a half-blade extend.

Finally, directions referenced as being upper or lower correspond to orientations perpendicular to the plane of rotation of the wiper blade, the denomination lower containing the plane of the windshield.

With reference to FIGS. 1 to 15, elements that are identical or functionally equivalent are identified by identical reference numerals.

FIG. 1 illustrates a wiper, particularly a motor vehicle windshield wiper, this wiper comprising a longitudinal wiper blade 10 and a blade carrying arm 12 which is partially depicted and is intended to be driven by a motor in order to follow an angular back and forth movement allowing water and possibly other undesirable elements with which the windshield is covered, to be moved aside.

The blade 10 here comprises a longitudinal cover member 14, a longitudinal wiper blade rubber 16, generally made of rubber, and at least one longitudinal spine 18 which stiffens the blade rubber 16 to encourage this blade rubber to press firmly against the windshield.

The cover member 14 of the blade 10 comprises an upper aerodynamic deflector 20 intended to improve the operation of the wiper, the purpose of this deflector being to improve the firm-pressing of the blade against the windshield and therefore the aerodynamic performance of the system.

The blade 10 further comprises end-fittings or clips 22 for attaching the blade rubber 16 and the spine 18 to the cover member 14, these clips 22 being situated at each of the longitudinal ends of the cover member 14.

The cover member 14 of the blade is produced here in two independent parts which are arranged essentially end-to-end and separated from one another by an intermediate connector 24. This connector 24 is therefore interposed between the two parts of the cover member 14 and may comprise means of fluidically connecting washer fluid supply means of the connector 24 to pipes of the member 14.

In order to mount it on the arm 12, the blade 10 comprises an adapter 26 mounted on the connector 24 and allowing the blade 10 to be articulated with respect to the arm 12. The articulation of the blade 10 with respect to the arm 12 is an articulation with a rotational movement about an axis of rotation Y perpendicular to the longitudinal axis of the blade 10. The blade 10 in fact needs to have at least one degree of freedom to rotate with respect to the arm 12 and, more specifically, with respect to an end piece 28 of the arm 12 so as to allow the blade 10 to follow the curvature of the windshield.

FIG. 2 depicts one embodiment of the wiper blade 10′ according to the invention, this blade 10′ comprising, in addition to the features described hereinabove with reference to FIG. 1, a longitudinal member 30a for supporting the blade rubber 16 and for supporting the spine 18.

The support member 30a comprises two lateral longitudinal hooks 46. These hooks 46 are substantially coplanar, each hook 46 extending laterally on the opposite side to the other hook. The hook 46 situated at the front of the blade 10′ thus extends forward and the hook 46 situated at the rear of the blade extends rearward. Each hook 46 at its free end comprises a longitudinal fastening tooth 48.

The cover member 14 may comprise a longitudinal channel 45 for the passage of washer fluid, which channel is connected to appropriate distribution means, for example at the connector 24.

The cover member 14 of the blade further comprises at its lower end means of attachment to the support member 30a. In the example depicted, the cover member 14 comprises two lateral longitudinal hooks 50 which are intended to collaborate with the hooks 46 of the support member 30a.

The hooks 50 are substantially coplanar and extend toward one another in order to define between them a slot in which the support member 30a can slide and is mounted. The hook 50 situated at the front of the blade thus extends rearward and the hook 46 situated at the front of the blade extends forward. Each hook 50 at its free end comprises a longitudinal catching tooth 52 intended to collaborate with the tooth 48 of the corresponding lip 46 of the support member 30a in order to limit the risks of accidental detachment of the cover member 14 with respect to the support member 30a.

The support member 30a of the blade 10 also comprises a first housing or lower housing 32 to accommodate a longitudinal heel 34 of the blade rubber 16. The blade rubber 16 is, for example, of the fir-tree type well known to those skilled in the art. Its upper end is connected by a hinge 36 and a damping member 38 to the heel 34. In the known way, during operation, the blade rubber 16 can come into abutment with the member 38 which damps its return forward or backward.

The housing 32 is configured to accommodate, by longitudinal sliding, the heel 34 of the blade rubber 16. This housing 32 is delimited by a longitudinal bottom wall 39 and by two lateral walls 40. The upper ends of the lateral walls 40 are connected to the bottom wall 39 and their lower ends are each connected to a longitudinal lip 41. These lips 41 are substantially coplanar and extend toward one another. Between them they delimit a slot in which a thinner lower part of the heel 34, which is substantially T-shaped in cross section, can slide and is mounted.

The support member 30a comprises a second housing or upper housing 42 for accommodating the spine 18, which thus extends above the heel 34 of the blade rubber.

The housing 42 is configured to accommodate the spine by longitudinal sliding. This housing 42 is delimited by the aforementioned bottom wall 39 and by two lateral walls 43. The lower ends of the lateral walls 43 are connected to the bottom wall 39 and their upper ends are each connected to a longitudinal lip 44. These lips 44 are substantially coplanar and extend toward one another.

The support member 30a comprises, in the housing 42, an upper longitudinal shoulder 47 along each lateral longitudinal edge of the bottom wall 39.

The spine 18 has a shape that is curved at rest and comprises a convex curved upper face and a concave curved lower face. As is also visible in the drawing, when the spine 18 is in the mounted position in its housing 42 (in which position the spine 18 is pressing against the shoulders 47), the lower face of the spine is situated facing the bottom wall 39 and some distance therefrom.

A heating element 49, such as a heating film, is fixed to the lower face of the spine 18 and extends some distance away from the bottom wall 39. This heating element 49 is made of a resistive material and is supplied with electricity via electrical conductors 51 which are arranged on the upper face of the spine 18.

The separation between the heating element 49 and the bottom wall 39 makes it possible to avoid thermal degradation thereof when the heating is activated. The support member (and particularly the bottom wall 39 thereof) is made of polypropylene (PP) in the prior art, this being a material that is a poor conductor of heat. In order to increase the heat energy transmitted to the blade, the thermal power of the heating film has therefore to be increased, and this is notably not economical.

The invention makes it possible to overcome this problem by virtue of the use of a thermally conducting material, for example, from which to make the support member 30a, as depicted in FIG. 2.

In the example depicted, parts of the support member 30a, mainly the bottom wall 39 and the shoulders 47 thereof, are made of a thermally conducting material, whereas the rest of the support member 30a is made of a material that is not thermally conducting, such as PP for example. This support member 30a may be produced by co-extrusion from two materials.

FIGS. 3 to 7 depict alternative forms of embodiment of the invention. The foregoing description relating to the blade 10′ of FIG. 2 applies to the blade 10′ of FIGS. 3 to 7 wherever said description is not in contradiction with that which follows.

In the embodiment depicted in FIG. 3, it is the support member 30b in its entirety which is made from a thermally conducting material. This support member 30b may be produced by extrusion from a thermally conducting material.

In the embodiment depicted in FIG. 4, the upper face of the bottom wall 39 of the support member 30c is covered with a layer 60 of thermally conducting material which may be in contact with the heating element 49 or some distance therefrom.

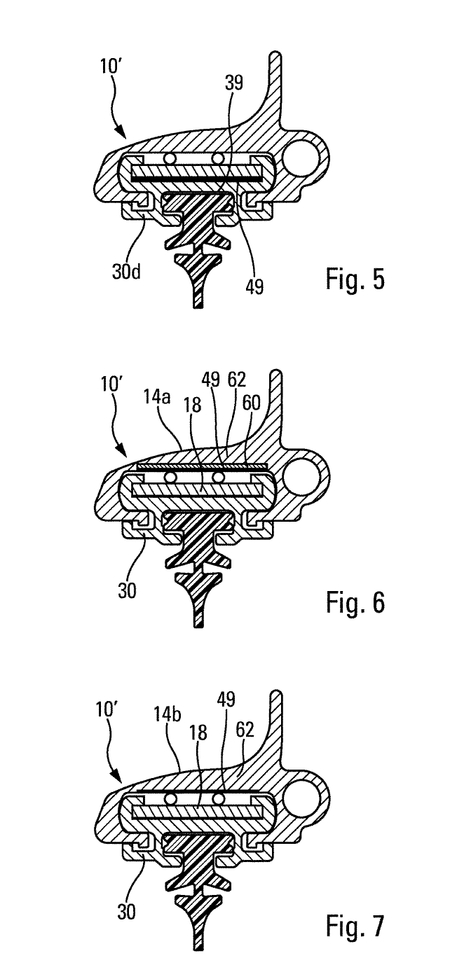

The embodiment depicted in FIG. 5 differs from that of FIG. 3 essentially in the support member 30d comprises no shoulder and that the heating element 49 is in contact with the bottom wall 39. The support member 30d is made entirely of thermally conducting material, for example by extrusion.

In the embodiments depicted in FIGS. 6 and 7, the heating element 49 is not fixed to the spine 18, but fixed to the cover member 14a, 14b of the blade 10′. The heating element 49 may take the form of a heating film. It may be fixed to a wall 62 of the cover member 14a, 14b which, in the mounted position, is substantially parallel to the spine 18 and substantially faces the latter. In the case of the cover member 14a of FIG. 6, a layer 60 of thermally conducting material is interposed between the heating element 49 and the wall 62 of the cover member 14a which member is made of a material that is not thermally conducting. In the case of the cover member 14b of FIG. 7, this cover member is made entirely from a thermally conducting material, for example by extrusion.

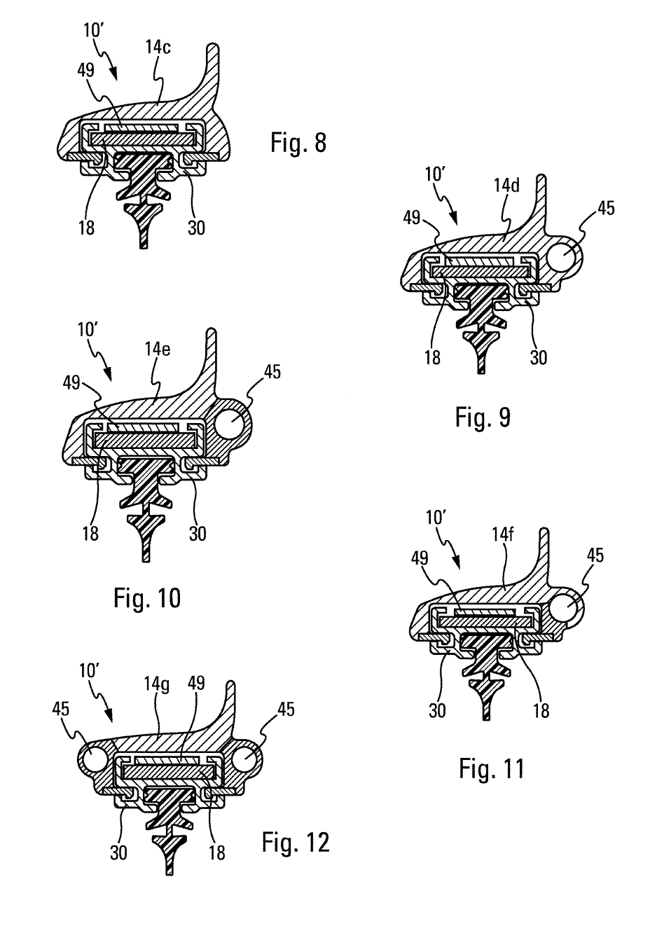

FIGS. 8 to 15 show other alternative forms according to the invention.

In FIG. 8, the cover element 14c is made entirely from a thermally conducting material, for example by extrusion. The heating element (film) 49 here is situated on the upper convex face of the spine 18 of the blade 10′. The cover element 14c here has no channel for the passage of washer fluid.

The cover element 14d of FIG. 9 differs from that of FIG. 8 in that it comprises a longitudinal channel 45 for the passage of washer fluid. The cover element 14d is made entirely from a thermally conducting material, for example by extrusion.

The cover element 14e of FIG. 10 differs from that of FIG. 9 in that only the part of the cover element comprising the longitudinal channel 45 is made from a thermally conducting material. The rest of the cover element 14e is made from a material that is not thermally conducting. This dual-material cover element 14e may be produced by co-extrusion. The channel 45 in cross section is of circular shape and is entirely, over 360°, surrounded by the thermally conducting material.

The cover element 14f of FIG. 11 differs from that of FIG. 10 in that the channel 45 is partially surrounded, over approximately 90-100°, with thermally conducting material, and partially surrounded, over approximately 260-270°, with a material that is not thermally conducting. The thermally conducting material is placed substantially between the channel 45 and the heating element (film) 49 so that the heat generated by the heating element is effectively transmitted to the channel 45.

The cover element 14g of FIG. 12 differs from that of FIG. 10 in that it comprises two longitudinal channels 45, namely one on each side of the blade 10′. As in FIG. 10, only the parts of the cover element 14g comprising the channels 45 are made from a thermally conducting material. The rest of the cover element is made from a material that is not thermally conducting. This dual-material cover element 14g may be produced by co-extrusion.

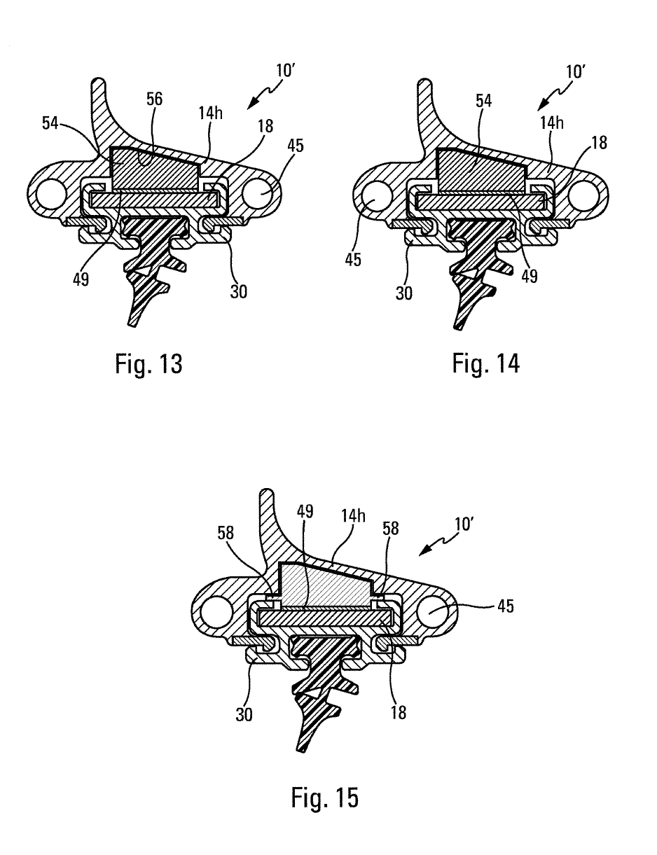

In the alternative forms of embodiment of FIGS. 13 to 15, at least one block of thermally conducting foam 54 is housed in the cover element 14h, and in this instance mounted between this cover element 14h and the spine 18. This may involve one or more blocks 54 of elongate shape extending along the longitudinal axis of the body 14h. When there are several blocks, these are arranged end-to-end along this longitudinal axis. The idea is to limit the empty volume inside the blade and make it easier for heat to spread within this blade. The block 54 may form a structural element of the blade or may even be considered to be a thick thermally conducting layer.

In the example depicted, the or each block has a parallelepipedal overall shape of which the upper end, situated on the same side as the cover element 14h, is chamfered. The upper end of the or of each block is housed here in a recess 56 of complementary shape belonging to the cover element 14h. The thickness of this element 14h is thereby reduced, making it possible to reduce the insulating effect that this element has and to improve the heat transfer. Moreover, the presence of the block or blocks 54 allows the element 14h not to collapse during operation under the effects of the flows of air that are applied to the blade, because it bears or may come to bear against the block 54. The improvement in thermal efficiency therefore makes it possible to reduce the power of the heating film 49, for the same effectiveness, and the risk of thermally degrading the various components.

In the case of FIG. 13, the or each block 54 is fixed, for example by gluing, to the spine 18. The heating film 49 here is interposed between the block 54 and the spine. The upper end of the block may be set a small clearance away from the walls of the recess 56 of the cover element 14h, or alternatively may rest against these walls in order to make it easier for heat to spread by conduction from the heating film 49 to the element 14h, passing via the block or blocks 54. The spine is made from a metallic or non-metallic material.

In the case of FIG. 14, the or each block 54 is fixed, for example by gluing, on the cover element 14h. The lower end of the block 54 may be spaced a small clearance away from the heating film but preferably rests against this heating element so as to make it easier for heat to spread by conduction as far as the element 14h. The cover element 14h may be made of a non-metallic material.

Finally, in the alternative form of embodiment of FIG. 15, the or each block 54 is fixed to the support member 30. In the example depicted, the or each block for that purpose comprises at least one lateral longitudinal rib 58 which extends and is fixed on an upper part of the member 30. The block 54 advantageously rests against the heating film 49 and may also rest against the cover element 14h. The support member 30 may be made of a non-metallic material.

1. A longitudinal structural element for a wiper blade for a motor vehicle, said structural element comprising:
a non-metallic main body comprising at least a part made from a thermally conducting material or covered with a layer of a non-metallic thermally conducting material.

2. The structural element as claimed in claim 1, wherein the thermally conducting material or the non-metallic thermally conducting material has a thermal conductivity greater than or equal to 1 W.m⁻¹.K⁻¹.

3. The structural element as claimed in claim 1, wherein in that the thermally conducting material or the non-metallic thermally conducting material comprises thermally conducting fillers.

4. The structural element as claimed in claim 1, wherein said main body further comprises a longitudinal housing for accommodating a longitudinal stiffening spine, said housing being delimited at least in part by a bottom wall and two lateral walls which are connected to said bottom wall, at least part of said bottom wall being produced from said thermally conducting material or covered with said layer of non-metallic thermally conducting material.

5. The structural element as claimed in claim 1, wherein said main body further comprises a longitudinal housing to house a heel of a wiper blade rubber.

6. The structural element as claimed in claim 1, wherein said main body further comprises at least one longitudinal channel for the passage of fluid and/or an aerodynamic deflector.

7. An assembly comprising:
a structural element as claimed in claim 3; and
a heating element being configured to heat said at least one part of the main body or said layer.

8. The assembly as claimed in claim 7, further comprising a longitudinal stiffening spine, said spine being mounted in said housing of the main body and comprising, at rest, a concave curved lower face, said heating element being interposed between said lower face of the spine and said bottom wall of the body.

9. The assembly as claimed in claim 8, wherein the heating element is fixed to said lower face of the spine and is either spaced away from said bottom wall or in contact therewith.

10. The assembly as claimed in claim 9, wherein the heating element is fixed to said bottom wall.

11. The assembly as claimed in claim 7, wherein the main body is made in its entirety from thermally conducting material.

12. The assembly as claimed in claim 7, wherein the main body is made by co-extrusion from two materials, one of which is said thermally conducting material.

13. A wiper blade for a motor vehicle, comprising a structural element as claimed in claim 1.

14. A method of manufacturing a structural element as claimed in claim 1, comprising:
extruding the main body of the structural element from a thermally conducting material; or
co-extruding the main body from a thermally conducting material and another material that is not thermally conducting; or
extruding the main body from a material that is not thermally conducting, and thereafter, applying a layer of non-resistive thermally conducting material to part of said body.

15. A wiper blade for a motor vehicle, comprising an assembly as claimed in claim 7.

16. The assembly as claimed in claim 7, wherein the heating element is a heating film.
